(19) United States
(12) Patent Application Publication
(10) Pub. No.: US 2026/0155309 A1
(43) Pub. Date: Jun. 4, 2026

(54) COMPOSITE ELECTRONIC COMPONENT

(71) Applicant: SAMSUNG ELECTRO-MECHANICS CO., LTD., Suwon-si (KR)

(72) Inventors: Jun Il SONG, Suwon-si (KR); Dong Uk KIM, Suwon-si (KR); Jae Min SONG, Suwon-si (KR); Jon Young PARK, Suwon-si (KR); Berm Ha CHA, Suwon-si (KR)

(73) Assignee: SAMSUNG ELECTRO-MECHANICS CO., LTD., Suwon-si (KR)

(21) Appl. No.: 19/312,987

(22) Filed: Aug. 28, 2025

(30) Foreign Application Priority Data
Dec. 4, 2024 (KR) 10-2024-0178890

(51) Int. Cl. H01G 4/30; H01G 4/232

(52) U.S. Cl. CPC H01G 4/30; H01G 4/232

(57) ABSTRACT

A composite electronic component includes an array in which two or more bodies including a dielectric layer and an internal electrode are arranged in a first direction; a first external electrode disposed on one surface of the two or more bodies in a second direction, perpendicular to the first direction; and a second external electrode disposed on the other surface of the two or more bodies in the second direction.

### CROSS-REFERENCE TO RELATED APPLICATION(S)

This application claims benefit of priority to Korean Patent Application No. 10-2024-0178890 filed on Dec. 4, 2024, the disclosure of which is incorporated herein by reference in their entireties.

### TECHNICAL FIELD

The present disclosure relates to a composite electronic component.

A multilayer ceramic capacitor (MLCC), a multilayer electronic component, may be a chip-type condenser mounted on the printed circuit boards of various electronic products, such as an image display device, including a liquid crystal display (LCD) or a plasma display panel (PDP), a computer, a smartphone, or a mobile phone, serving to charge or discharge electricity therein or therefrom.

In order to achieve high efficiency and high-density integration, there is a case in which various chip-type condensers are joined and used in a stack form. In the prior art, an epoxy-based bonding agent, a Cu—Sn alloy, or the like, was used to join various chip-type condensers. Referring to FIG. 10, which illustrates a conventional stack-type condenser, external electrodes of adjacent chips were joined using an epoxy-based bonding agent or Cu—Sn alloys 41 and 42 to form a stack-type condenser. However, the conventional stack-type condenser could cause cracks to occur in a joint portion due to vibrations or external impacts during use. In addition, there may be a concern that electrical conductivity may decrease and equivalent series resistance (ESR) may increase.

### SUMMARY

An aspect of the present disclosure is to provide a composite electronic component having excellent reliability.

An aspect of the present disclosure is to provide a composite electronic component having high crack resistance.

An aspect of the present disclosure is to provide a composite electronic component having low equivalent series resistance (ESR).

An aspect of the present disclosure is to provide a composite electronic component having excellent heat dissipation characteristics.

However, various problems to be solved by the present disclosure are not limited to the above-described contents, and can be more easily understood in the process of explaining specific embodiments of the present disclosure.

According to an aspect of the present disclosure, a composite electronic component includes an array in which two or more bodies including a dielectric layer and an internal electrode are arranged in a first direction; a first external electrode disposed on one surface of the two or more bodies in a second direction, perpendicular to the first direction; and a second external electrode disposed on the other surface of the two or more bodies in the second direction, wherein the first external electrode includes a first inner band portion extending between two adjacent bodies among the two or more bodies and a first outer band portion disposed on the outermost side in the first direction, and the second outer electrode includes a second inner band portion extending between the two adjacent bodies and a second outer band portion disposed on the outermost side in the first direction, wherein an insulating joint bonding the adjacent bodies may be disposed in a portion between the first and second inner band portions facing each other in the second direction.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a composite electronic component according to an embodiment of the present disclosure;

FIG. 2 schematically illustrates a cross-sectional view of FIG. 1, taken along line I-I′;

FIG. 3 schematically illustrates a cross-sectional view of FIG. 1, taken along line II-II′;

FIG. 4 schematically illustrates a perspective view of a body;

FIG. 5 is an exploded perspective view illustrating a disassembled body;

FIG. 6 is an enlarged view of a lower portion of a composite electronic component of FIG. 2 in an X-direction;

FIG. 7 is an enlarged view of region K1 of FIG. 6;

FIG. 8 is a view corresponding to FIG. 2 of a composite electronic component according to another embodiment of the present disclosure;

FIG. 9 is a view corresponding to FIG. 2 of a composite electronic component according to another embodiment of the present disclosure;

FIG. 10 is a view corresponding to FIG. 2 of a composite electronic component of a conventional stack form; and

FIG. 11 is an enlarged view of region K2 of FIG. 10.

### DETAILED DESCRIPTION

Hereinafter, some embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, an X-direction may be defined as a first direction, a stacking direction, or a thickness (T) direction, a Y-direction may be defined as a second direction or a length (L) direction, and a Z-direction may be defined as a third direction or a width (W) direction.

### Composite Electronic Component

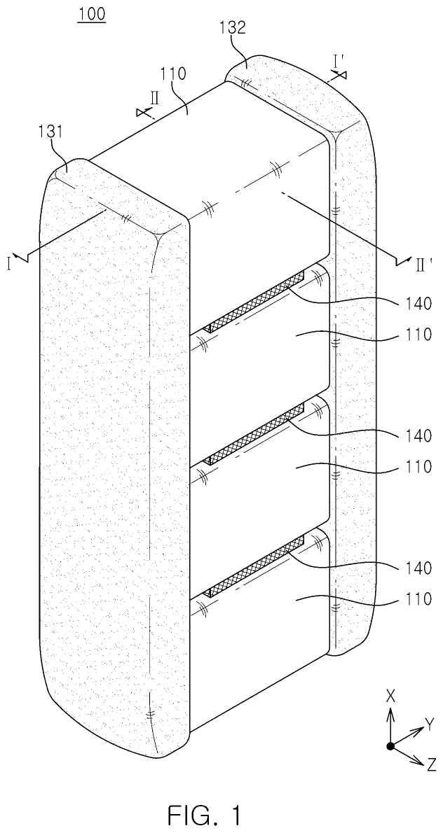

FIG. 1 schematically illustrates a perspective view of a multilayer electronic component according to an embodiment of the present disclosure.

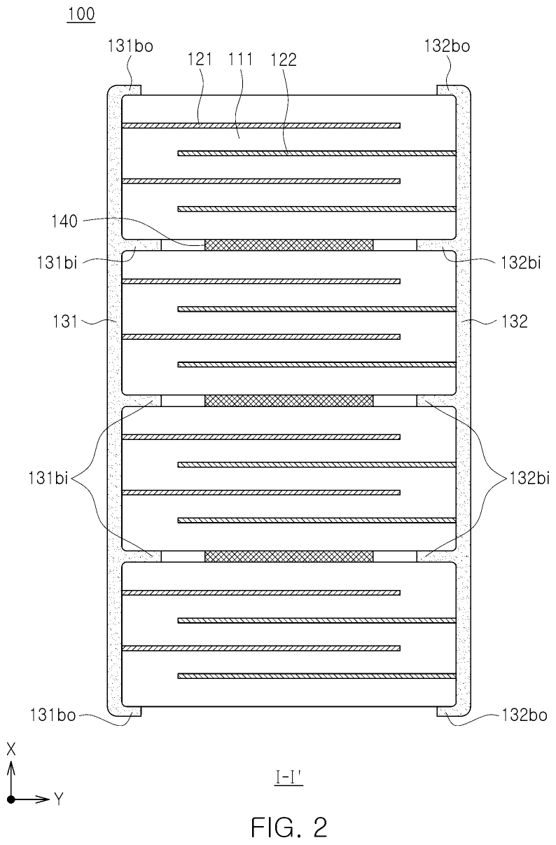

FIG. 2 schematically illustrates a cross-sectional view of FIG. 1, taken along line I-I′.

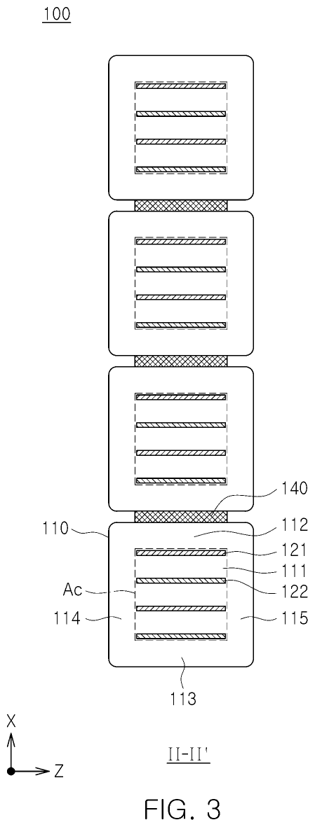

FIG. 3 schematically illustrates a cross-sectional view of FIG. 1, taken along line II-II′.

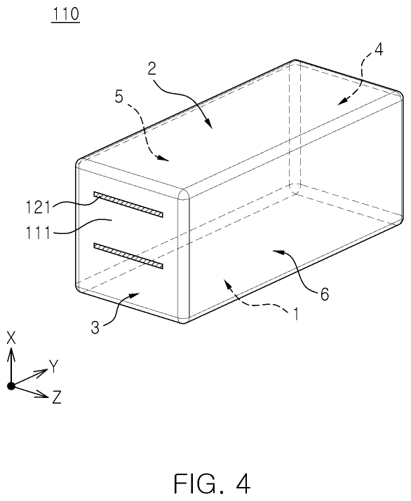

FIG. 4 schematically illustrates a perspective view of a body.

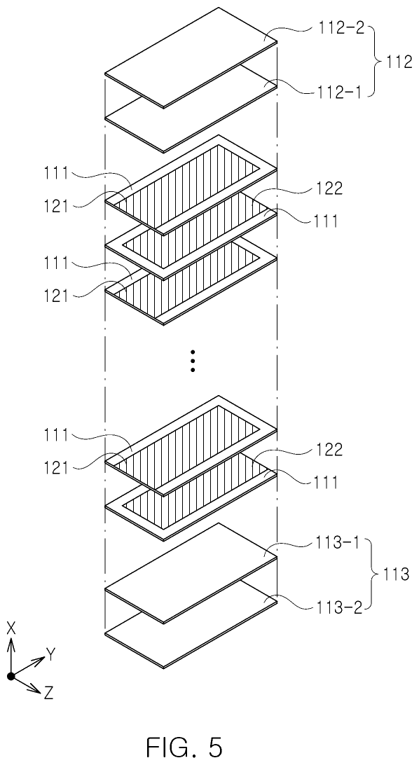

FIG. 5 is an exploded perspective view illustrating a disassembled body.

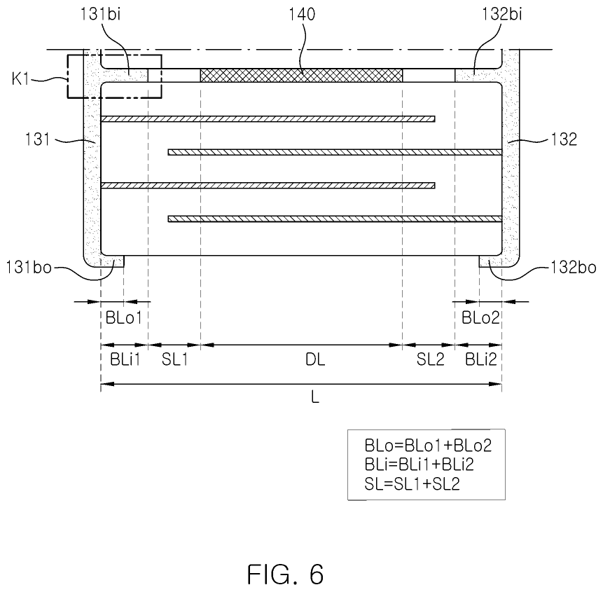

FIG. 6 is an enlarged view of a lower portion of a composite electronic component of FIG. 2 in an X-direction of FIG. 2.

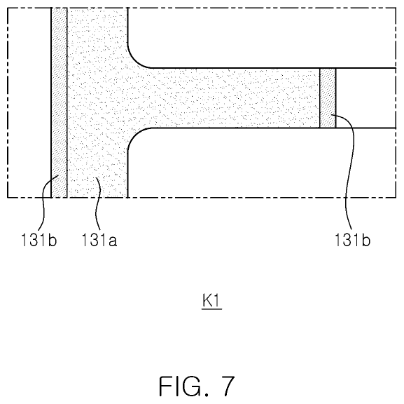

FIG. 7 is an enlarged view of region K1 of FIG. 6.

Hereinafter, a composite electronic component 100 according to an embodiment of the present disclosure will be described in detail with reference to FIGS. 1 to 7. In addition, a multilayer ceramic capacitor (hereinafter, referred to as ‘MLCC’) will be described as an example of a multilayer electronic component, but the present disclosure is not limited thereto, and may also be applied to various multilayer electronic components using a ceramic material, such as an inductor, a piezoelectric element, a varistor, a thermistor, or the like.

According to some aspects of the present disclosure, the composite electronic component 100 includes an array in which two or more bodies 110 including a dielectric layer 111 and internal electrodes 121 and 122 are arranged in a first direction; a first external electrode 131 disposed on one surface of the two or more bodies in a second direction, perpendicular to the first direction; and a second external electrode 132 disposed on the other surface of the two or more bodies in the second direction, wherein the first external electrode includes a first inner band portion 131bi extending between two adjacent bodies among the two or more bodies and a first outer band portion 131bo disposed on the outermost side in the first direction, and the second external electrode includes a second inner band portion 132bi extending between the two adjacent bodies and a second outer band portion 132bo disposed on the outermost side in the first direction, wherein an insulating joint 140 bonding the adjacent bodies may be disposed in a portion between the first and second inner band portions facing each other in the second direction.

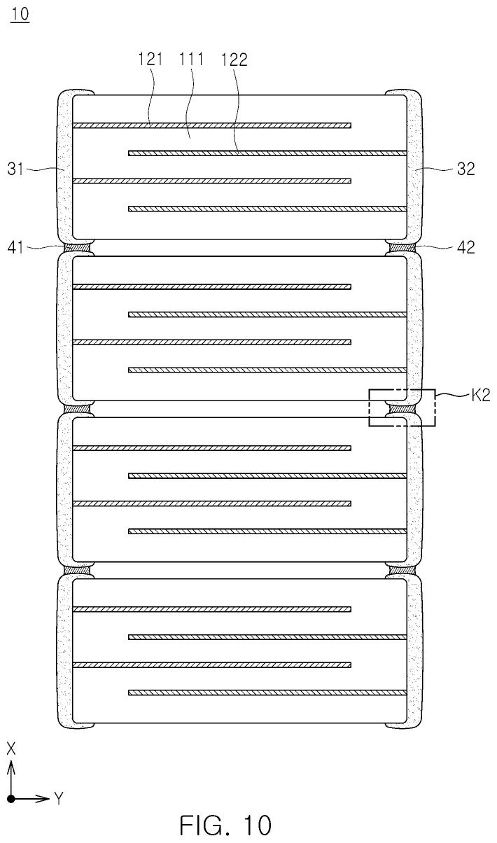

In order to achieve high efficiency and high-density integration, there is a case in which various chip-type condensers are joined and used in a stack form. In the prior art, an epoxy-based bonding agent, a Cu—Sn alloy, or the like, was used to join various chip-type condensers. Referring to FIG. 10, which illustrates a conventional stack-type condenser, external electrodes of adjacent chips joined using an epoxy-based bonding agent or Cu—Sn alloys 41 and 42 to form a stack-type condenser. However, the conventional stack-type condenser could cause cracks to occur in a joint portion due to vibrations or external impacts during use. In addition, there may be a concern that electrical conductivity may decrease and equivalent series resistance (ESR) may increase.

On the other hand, according to some embodiments of the present disclosure, by bonding adjacent bodies 110 with an insulating joint 140, the joint force between the bodies may be improved. In addition, according to some embodiments of the present disclosure, by disposing an insulating joint 140 in a portion between the first and second inner band portions 131bi and 132bi, the heat dissipation characteristics may be improved. In addition, according to some embodiments of the present disclosure, rather than disposing external electrodes on each of the plurality of bodies 110, by connecting the plurality of bodies 110 to one first external electrode 131 and one second external electrode 132, the equivalent series resistance (ESR) may be reduced.

Hereinafter, each component included in the composite electronic component 100 according to some embodiments of the present disclosure will be described.

The body 110 may have a dielectric layer 111 and internal electrodes 121 and 122 alternately stacked.

Although the specific shape of the body 110 is not particularly limited, the body 110 may have a hexahedral shape or a shape similar to the hexahedral shape, as illustrated in the drawings. Due to shrinkage of ceramic powder particles included in the body 110 during a sintering process, the body 110 may not have a hexahedral shape having a perfectly straight line, but may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

As a margin region in which the internal electrodes 121 and 122 are not disposed overlaps the dielectric layer 111, a step portion may be formed by thicknesses of the internal electrodes 121 and 122, so that a corner connecting the first surface to the third to fifth surfaces and/or a corner connecting the second surface to the third to fifth surfaces may have a shape contracted to a center of the body 110 in the first direction when viewed with respect to the first surface or the second surface. Alternatively, by shrinkage behavior during the sintering process of the body 110, a corner connecting the first surface 1 to the third to sixth surfaces 3, 4, 5, and 6 and/or a corner connecting the second surface 2 to the third to sixth surfaces 3, 4, 5, and 6 may have a shape contracted to the center of the body 110 in the first direction when viewed with respect to the first surface or the second surface. Alternatively, as a corner connecting respective surfaces of the body 110 to each other is rounded by performing an additional process to prevent chipping defects, or the like, the corner connecting the first surface to the third to sixth surfaces and/or the corner connecting the second surface to the third to sixth surfaces may have a rounded shape.

Meanwhile, in order to suppress a step portion formed by the internal electrodes 121 and 122, after the internal electrodes are cut so as to be exposed to the fifth and sixth surfaces 5 and 6 of the body after lamination, when margin portions 114 and 115 are formed by stacking a single dielectric layer or two or more dielectric layers on both side surfaces of a capacitance formation portion (Ac) in a third direction (width direction), a portion connecting the first surface to the fifth and sixth surfaces and a portion connecting the second surface to the fifth and sixth surfaces may not have a contracted form.

A plurality of dielectric layers 111 forming the body 110 may be in a sintered state, and adjacent dielectric layers 111 may be integrated with each other, such that boundaries therebetween may not be readily apparent without using a scanning electron microscope (SEM). The number of stacked dielectric layers is not particularly limited, and may be determined by considering the size of the composite electronic component. For example, 400 or more dielectric layers may be stacked to form a body.

The dielectric layer 111 may be formed by manufacturing a ceramic slurry including a ceramic powder, an organic solvent, and a binder, applying the slurry to a carrier film and drying the same to prepare a ceramic green sheet, and then sintering the ceramic green sheet. The ceramic powder is not particularly limited as long as sufficient electrostatic capacitance may be obtained therewith, but, for example, barium titanate-based (BaTiO₃) powder may be used as the ceramic powder. For a more specific example, the ceramic powder may include barium titanate-based (BaTiO₃) powder, CaZrO₃-based paraelectric powder, or the like. For a more specific example, the barium titanate-based (BaTiO₃) powder may be at least one selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), and Ba(Ti_{1-y}Zr_{y})O₃ (0<y<1), and the CaZrO₃-based paraelectric powder may be (Ca₁₋ₓSrₓ)(Zr_{1-y}Ti_{y})O₃ (0<x<1, 0<y<1).

Accordingly, the dielectric layer 111 may include at least one selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), and (Ca₁₋ₓSrₓ)(Zr_{1-y}Ti_{y})O₃ (0<x<1, 0<y<1). In some embodiments, the dielectric layer 111 may include (Ca₁₋ₓSrₓ)(Zr_{1-y}Ti_{y})O₃ (0<x<1, 0<y<1) as a main component.

Meanwhile, when a magnetic material is applied to the body 110 instead of a dielectric material, the composite electronic component may function as an inductor. The magnetic material may be, for example, ferrite and/or metal magnetic particles. When the composite electronic component functions as an inductor, the internal electrode may be a coil-type conductor.

In addition, when a piezoelectric material is applied to the body 110 instead of a dielectric material, the composite electronic component may function as a piezoelectric element. The piezoelectric material may be, for example, PZT (lead titanate zirconate).

In addition, when a ZnO-based or SiC-based material is applied to the body 110 instead of a dielectric material, the composite electronic component may function as a varistor, and when a spinel-based material is applied to the body 110 instead of a dielectric material, the composite electronic component may function as a thermistor.

That is, the composite electronic component 100 according to some embodiments of the present disclosure may function as an inductor, a piezoelectric element, a varistor, or a thermistor as well as a multilayer ceramic capacitor by appropriately changing a material or structure of the body 110.

A size of the body 110 is not particularly limited. For example, a length (L) of the body 110 in the second direction may be 3.1 to 3.3 mm, a thickness of the body 110 in the first direction may be 2.4 to 2.6 mm, and a width of the body 110 in the third direction may be 2.4 to 2.6 mm. However, some embodiments thereof is limited thereto and may be appropriately modified depending on the usage environment and purpose thereof.

The body 110 may include a capacitance formation portion (Ac) disposed in the body 110, and including a first internal electrode 121 and a second internal electrode 122 disposed to oppose each other with the dielectric layer 111 interposed therebetween and having capacitance formed therein, and cover portions 112 and 113 formed above and below the capacitance formation portion (Ac) in the first direction.

In addition, the capacitance formation portion (Ac) is a portion serving to contribute to capacitance formation of a capacitor, and may be formed by repeatedly stacking a plurality of first and second internal electrodes 121 and 122 with a dielectric layer 111 interposed therebetween.

The cover portions 112 and 113 may include an upper cover portion 112 disposed above the capacitance formation portion (Ac) in the first direction and a lower cover portion 113 disposed below the capacitance formation portion (Ac) in the first direction.

The upper cover portion 112 and the lower cover portion 113 may be formed by stacking a single dielectric layer or two or more dielectric layers 112-1, 112-2, 113-1, and 113-2 on the upper and lower surfaces of the capacitance formation portion (Ac) in a thickness direction, respectively, and the upper cover portion 112 and the lower cover portion 113 may serve to basically prevent damage to the internal electrodes due to physical or chemical stress.

The upper cover portion 112 and the lower cover portion 113 may not include internal electrodes, and may include the same material as that of the dielectric layer 111.

That is, the upper cover portion 112 and the lower cover portion 113 may include a ceramic material, for example, a barium titanate (BaTiO₃)-based ceramic material.

Meanwhile, a thickness of the cover portions 112 and 113 is not particularly limited. For example, the thickness “tc” of the cover portions 112 and 113 may be 100 μm or less, 30 μm or less, or 20 μm or less. Here, an average thickness of the cover portions 112 and 113 means an average thickness of each of the first cover portion 112 and the second cover portion 113.

The average thickness “tc” of the cover portions 112 and 113 may mean a size thereof in the first direction, and may be a value obtained by averaging sizes of the cover portions 112 and 113 in the first direction, measured at 5 equally spaced points in the second direction in a cross-section thereof in the first and second directions, cut from the center of the body 110 in the third direction.

In addition, margin portions 114 and 115 may be disposed on a side surface of the capacitance formation portion (Ac).

The margin portions 114 and 115 may include a first margin portion 114 disposed on the fifth surface 5 of the body 110 and a second margin portion 115 disposed on the sixth surface 6 of the body 110. That is, the margin portions 114 and 115 may be disposed on both end surfaces of the ceramic body 110 in a width direction.

The margin portions 114 and 115 may mean a region between both ends of the first and second internal electrodes 121 and 122 and a boundary surface of the body 110 in a cross-section, cut of the body 110 in the width-thickness (W-T) direction, as illustrated in FIG. 3.

The margin portions 114 and 115 may basically serve to prevent damage to the internal electrodes due to physical or chemical stress.

The margin portions 114 and 115 may be formed by applying a conductive paste to the ceramic green sheet, except where margin portions are to be formed, to form an internal electrode.

In addition, in order to suppress a step portion by the internal electrodes 121 and 122, after the internal electrodes are cut so as to be exposed to the fifth and sixth surfaces 5 and 6 of the body after lamination, the margin portions 114 and 115 may also be formed by stacking a single dielectric layer or two or more dielectric layers on both side surfaces of the capacitance formation portion (Ac) in the third direction (width direction).

Meanwhile, a width of the margin portions 114 and 115 is not particularly limited. For example, an average width of the margin portions 114 and 115 may be 100 μm or less, 20 μm or less, or 15 μm or less. Here, the average width of the margin portions 114 and 115 means an average thickness of each of the first margin portion 114 and the second margin portion 115.

The average width of the margin portions 114 and 115 may mean an average size in the third direction of a region in which the internal electrode is spaced apart from the fifth surface and an average size in the third direction of a region in which the internal electrode is spaced apart from the sixth surface, and may be a value obtained by averaging sizes of the margin portions 114 and 115 in the third direction, measured at 5 equally spaced points, on a side surface of the capacitance formation portion (Ac).

The internal electrodes 121 and 122 may include first and second internal electrodes 121 and 122. The first and second internal electrodes 121 and 122 may be alternately disposed to face each other with the dielectric layer 111 forming the body 110 interposed therebetween, and may be exposed to the third and fourth surfaces 3 and 4 of the body 110, respectively.

The first internal electrode 121 may be spaced apart from the fourth surface 4 and be exposed through the third surface 3, and the second internal electrode 122 may be spaced apart from the third surface 3 and be exposed through the fourth surface 4. A first external electrode 131 may be disposed on the third surface 3 of the body and be connected to the first internal electrode 121, and a second external electrode 132 may be disposed on the fourth surface 4 of the body and be connected to the second internal electrode 122.

That is, the first internal electrode 121 may not be connected to the second external electrode 132 and be connected to the first external electrode 131, and the second internal electrode 122 may not be connected to the first external electrode 131 and be connected to the second external electrode 132. Accordingly, the first internal electrode 121 may be formed to be spaced apart from the fourth surface 4 by a predetermined distance, and the second internal electrode 122 may be formed to be spaced apart from the third surface 3 by a predetermined distance. In addition, the first and second internal electrodes 121 and 122 may be disposed to be spaced apart from the fifth and sixth surfaces of the body 110.

However, it is not limited to this form, and the first internal electrode and the second internal electrode may be alternately disposed with a dielectric layer interposed therebetween, the first internal electrode may include a 1-1 internal electrode connected to the first external electrode and a 1-2 internal electrode connected to the second external electrode, and the second internal electrode may have a floating electrode form disposed to be spaced apart from the first and second external electrodes.

The conductive metal included in the internal electrodes 121 and 122 may be at least one selected from the group consisting of Ni, Cu, Pd, Ag, Au, Pt, In, Sn, Al, Ti, and alloys thereof, but the present disclosure is not limited thereto.

An average thickness “td” of the dielectric layer 111 is not particularly limited, but may be, for example, 0.1 μm to 10 μm. An average thickness “the” of the internal electrodes 121 and 122 is not particularly limited, but may be, for example, 0.05 μm to 3.0 μm. In addition, the average thickness “td” of the dielectric layer 111 and the average thickness “the” of the internal electrodes 121 and 122 may be arbitrarily set according to the desired characteristics or purpose.

The average thickness “td” of the dielectric layer 111 and the average thickness “the” of the internal electrodes 121 and 122 refer to sizes of the dielectric layer 111 and the internal electrodes 121 and 122 in the first direction, respectively. The average thickness “td” of the dielectric layer 111 and the average thickness “the” of the internal electrodes 121 and 122 may be measured by scanning cross-sections of the body 110 in the first and second directions using a scanning electron microscope (SEM) at a magnification of 10,000. More specifically, an average value may be measured by measuring a thickness of one dielectric layer 111 at a plurality of points of one dielectric layer 111, for example, at 30 equally spaced points in the second direction. In addition, an average value may be measured by measuring a thickness of one of the internal electrodes 121 and 122 at a plurality of points of one of the internal electrodes 121 and 122, for example, at 30 equally spaced points in the second direction. The 30 equally spaced points may be designated in a capacitance formation portion (Ac). Meanwhile, if the average value is measured by extending the average value measurement to 10 dielectric layers 111 and 10 internal electrodes 121 and 122, respectively, the average thickness “td” of the dielectric layer 111 and the average thickness “the” of the internal electrodes 121 and 122 may be further generalized.

The insulating joint 140 may serve to bond two adjacent bodies 110. The insulating joint 140 may be disposed in a portion between the first and second inner band portions 131bi and 132bi facing each other in the second direction. When the insulating joint 140 is disposed in the entire region between the first and second inner band portions 131bi and 132bi, there may be a concern that the heat dissipation function may be deteriorated.

The external electrodes 131 and 132 may include a first external electrode 131 disposed on one surface of two or more bodies in the second direction and a second external electrode 132 disposed on the other surface thereof in the second direction. The first external electrode 131 may cover one surfaces of two or more bodies in the second direction, and the second external electrode 132 may cover the other surfaces of two or more bodies in the second direction.

That is, according to some embodiments of the present disclosure, rather than disposing external electrodes on the plurality of bodies 110, respectively, the equivalent series resistance (ESR) may be reduced by connecting the plurality of bodies 110 to one first external electrode 131 and one second external electrode 132.

The first external electrode 131 may include a first inner band portion 131bi extending between two adjacent bodies among the two or more bodies and a first outer band portion 131bo disposed on the outermost side in the first direction, and the second external electrode 132 may include a second inner band portion 132bi extending between the two adjacent bodies and a second outer band portion 132bo disposed on the outermost side in the first direction. Accordingly, not only may the bonding force between the external electrodes 131 and 132 and the plurality of bodies be improved, but also the impact resistance against external impacts may be further improved compared to a case in which only an insulating joint 140 is disposed in a space between the adjacent bodies.

A method for forming the external electrodes 131 and 132 is not particularly limited, and for example, a plurality of bodies before sintering obtained by cutting a laminate into chip units and joined using an insulating bonding agent, and then a body may be obtained through a sintering process, and the body may be dipped in a paste for external electrodes and then heat treated to form external electrodes 131 and 132.

The external electrodes 131 and 132 may be formed using any material as long as it has electrical conductivity, such as metal, or the like, and a specific material may be determined in consideration of electrical characteristics and structural stability, and furthermore, may have a multilayer structure.

For example, the first external electrode 131 may include an electrode layer 131a disposed on the body 110 and a plating layer 131b formed on the electrode layer, and the second external electrode 132 may also include an electrode layer and a plating layer. The following description will focus on the first external electrode 131, but there is only a difference in that the first external electrode 131 is disposed on the third surface and the second external electrode 132 is disposed on the fourth surface, but the configurations of the first external electrode 131 and the second external electrode 132 are similar, and therefore, the description of the first external electrode 131 is considered to include a description of the second external electrode 132.

For a more specific example of the electrode layer 131a, the electrode layer may be a sintered electrode including a conductive metal and glass, or a resin-based electrode including a conductive metal and glass.

In addition, the electrode layer 131a may have a form in which a sintered electrode and a resin-based electrode are sequentially formed on the body. In addition, the electrode layer 131a may be formed by transferring a sheet including a conductive metal onto the body, or may be formed by transferring a conductive metal onto the sintered electrode.

A material having excellent electrical conductivity may be used as a conductive metal included in the electrode layer 131a, and is not particularly limited. For example, the conductive metal may be at least one selected from the group consisting of nickel (Ni), copper (Cu), and alloys thereof.

The plating layer 131b may serve to improve mounting characteristics. A type of the plating layer 131b is not particularly limited, and may be a plating layer including at least one of Ni, Sn, Pd, and alloys thereof, and may be formed of a plurality of layers.

In some embodiments, the first inner band portion 131bi and the second inner band portion 132bi may be disposed to contact both of the two adjacent bodies. According to some embodiments of the present disclosure, rather than disposing external electrodes on each of the plurality of bodies 110, the plurality of bodies 110 may be connected to one first external electrode 131 and one second external electrode 132, and therefore, the first inner band portion 131bi and the second inner band portion 132bi may be disposed to contact both of the two adjacent bodies.

In some embodiments, the first inner band portion 131bi may be longer in the second direction than the first outer band portion 131bo, and the second inner band portion 132bi may be longer in the second direction than the second outer band portion 132bo. Accordingly, the bonding force between the external electrode and the body may be improved, and the bonding force between adjacent bodies may also be improved.

Meanwhile, it is not necessary to dispose only one insulating joint 140 between the first and second inner band portions facing each other in the second direction.

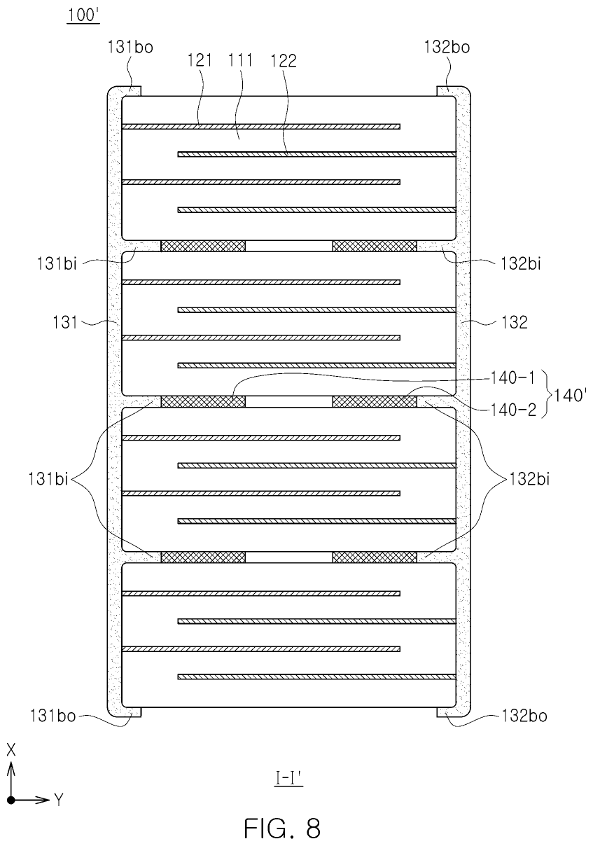

FIG. 8 is a view corresponding to FIG. 2 of a composite electronic component 100′ according to another embodiment of the present disclosure. Referring to FIG. 8, an insulating joint 140′ may include a first insulating joint 140-1 in contact with the first inner band portion 131bi and a second insulating joint 140-2 spaced apart from the first insulating joint in the second direction and in contact with the second inner band portion 132bi.

As an insulating joint is formed and then an external electrode is formed, the first insulating joint 140-1 may play a role of controlling the length of the first inner band portion 131bi, and the second insulating joint 140-2 may play a role of controlling the length of the second inner band portion 132bi.

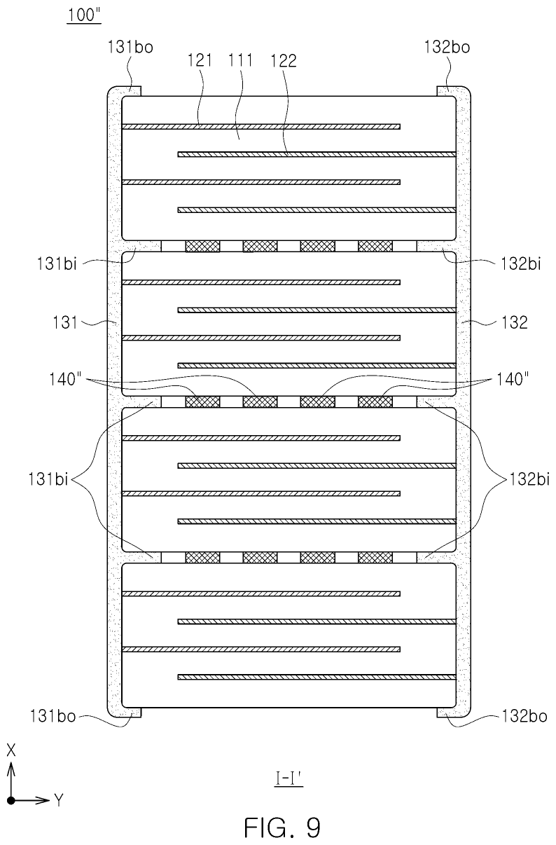

FIG. 9 is a view corresponding to FIG. 2 of a composite electronic component 100″ according to another embodiment of the present disclosure. Referring to FIG. 9, two or more insulating joints 140″ may be disposed between the first and second inner band portions facing each other in the second direction. Since a plurality of insulating joints 140″ are disposed, a plurality of empty spaces may be formed between adjacent bodies as illustrated in FIG. 9, thereby further improving heat dissipation characteristics.

Referring to FIG. 6, which is an enlarged view of a lower portion of a composite electronic component of FIG. 2 in an X-direction, in some embodiments, when a length of the body in the second direction is referred to as L, a space among spaces between the first and second inner band portions facing each other in the second direction, in which the insulating joint is not disposed, is referred to as a separation portion, and a length of the separation portion is referred to as SL, SL/L may be 0.03 or more and 0.59 or less. Accordingly, the heat dissipation characteristics may be further improved the joint strength may not be reduced. When SL/L is less than 0.03, the heat dissipation characteristics may be deteriorated, and when SL/L exceeds 0.59, there may be a concern that the joint strength may be reduced.

In some embodiments, when the length of the body in the second direction is referred to as L and the length of the insulating joint in the second direction is referred to as DL, DL/L may be 0.03 or more and 0.59 or less. Accordingly, the joint strength may be further improved and the heat dissipation characteristics may not be reduced. When DL/L is less than 0.03, there may be a concern that the joint strength may be reduced, and when DL/L exceeds 0.59, the heat dissipation characteristics may be deteriorated.

In some embodiments, when the length of the body in the second direction is referred to as L, and the sum of lengths of the first and second inner band portions in the second direction facing each other in the second direction is referred to as BLi, BLi/L may be 0.37 or more and 0.5 or less. Accordingly, the joint force between the external electrode and the body may be secured, and at the same time, the joint strength between the bodies may be further improved.

In some embodiments, when the sum of lengths of the first and second inner band portions in the second direction facing each other in the second direction is referred to as BLi, and the sum of lengths of the first and second outer band portions in the second direction facing each other in the second direction is referred to as Blo, BLo may be smaller than BLi. That is, the length of the inner band portion may be longer than the length of the outer band portion, and the bonding force between the external electrode and the body may be further improved, and the moisture resistance reliability may also be further improved. The length of the first inner band portion may be longer than the length of the first outer band portion, and the length of the second inner band portion may be longer than the length of the second outer band portion.

For a specific example, Blo/BLi may be 0.75 or more and less than 1.

In some embodiments, the array may include three or more bodies 110. Accordingly, high efficiency and high-density integration may be more easily achieved.

Meanwhile, as illustrated in FIG. 3, a stacking direction of the dielectric layer 111 and the internal electrodes 121 and 122 and a stacking direction of the bodies may be the same. However, it is not necessary to be limited thereto, and the bodies may be stacked in a direction, perpendicular to the stacking directions of the dielectric layer 111 and the internal electrodes 121 and 122.

In some embodiments, the first and second external electrodes 131 and 132 may include an electrode layer and a plating layer disposed on the electrode layer.

Referring to FIG. 7, which is an enlarged view of region K1 of FIG. 6, the first external electrode 131 may include an electrode layer 131a and a plating layer 131b disposed on the electrode layer 131a, and the second external electrode 132 may also include an electrode layer and a plating layer, similar to the first external electrode 131.

In some embodiments, a plating layer may not be disposed in a central portion of the first inner band portion in the second direction and a central portion of the second inner band portion in the second direction. In some embodiments, the first and second inner band portions may have plating layers disposed only at the ends facing each other.

Since the inner band portions 131bi and 132bi are in contact with two adjacent bodies, a plating layer may not be disposed in the central portion of the first inner band portion 131bi in the second direction and the central portion of the second inner band portion 132bi in the second direction, and the first and second inner band portions 131bi and 132bi may have plating layers disposed only at the ends facing each other.

However, when an insulating joint 140 is disposed at the ends of the inner band portions 131bi and 132bi, the first and second band portions 131bi and 132bi may not include a plating layer.

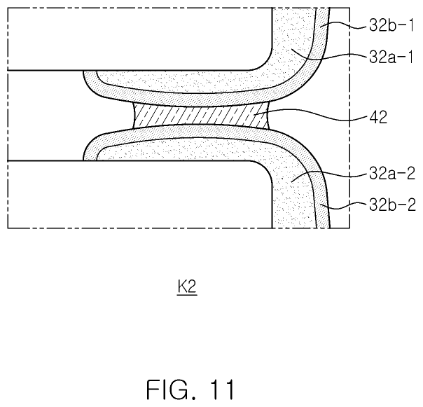

On the other hand, referring to FIG. 10 illustrating a conventional stack-type condenser, and FIG. 11, which is an enlarged view of region K2 of FIG. 10, as external electrodes formed on different bodies are joined to joints 41 and 42 using an epoxy-based bonding agent or a Cu—Sn alloy, electrode layers 32a-1 and 32a-2 are separately disposed on each of the bodies, and plating layers 32b-1 and 32b-2 are separately disposed on each of the electrode layers 32a-1 and 32a-2. Accordingly, it can be confirmed that the plating layers 32b-1 and 32b-2 are disposed on the entire outer surface of the band portion disposed between adjacent bodies, and it can be confirmed that two band portions are separated by the joints 41 and 42 between the adjacent bodies.

The insulating joint 140 may use a material having excellent joint force with the dielectric and insulating properties. For a specific example, the insulating joint 140 may include a glass component, and the glass component may include at least one selected from the group consisting of SiO₂, B₂O₃, BaO, CaO, Na₂O, ZnO, Al₂O₃, and PbO.

### Example

Comparative Examples 1 to 4 and Inventive Examples 1 to 4 illustrate that a sample stack having the form illustrated in FIG. 1 was produced by changing a length of the inner band portion BLi, a length of the separation portion SL, and a length of the insulating joint DL.

Comparative Example 5 illustrates a conventional stack-type condenser as illustrated in FIG. 10, and external electrodes of adjacent chips were joined using a Cu—Sn alloy to form a stack-type condenser.

Joint strength, heat generation characteristics, and moisture resistance reliability of Comparative Examples 1 to 5 and Inventive Examples 1 to 4 were evaluated and are described in Table 1 below.

The joint strength was measured by performing a three-point bending test with a universal material tester, based on external force which caused cracks in the band portion of the external electrode disposed between the body and the body and/or the insulating joint or caused the external electrode to be separated from the body. The joint strength of Comparative Example 5 was set as a 100% reference value, and relative values of the remaining test numbers were recorded.

The heat generation characteristics were measured by preparing five sample stacks for each test number, disposing the sample stacks on a hot plate at 105° C., and then applying a rated voltage to the sample stacks at 200 kHz using an amplifier. While the sample stack is observed with a thermal imaging camera, an AC voltage applied to the sample stack was measured with an I-V Analyzer until a temperature of the hot plate reached 125° C., and an average value for five sample stacks was obtained. The higher the average value of AC voltage, the better the heat generation characteristics may be determined. The relative values of the remaining test numbers are described in Table 1 below, with the average AC voltage of test number 2 as 100%.

The moisture resistance reliability was measured by preparing 400 sample stacks for each test number, applying a voltage of 4 V for 12 hours at a temperature of 85° C. and a relative humidity of 85%, and the number of sample stacks of which an insulation resistance value has decreased to 1/10 or less compared to the initial value.

TABLE 1

| | Length of | Length of | Length of | Length of | | Heat | Moisture |
|---|---|---|---|---|---|---|---|
| | outer band | inner band | separation | insulating | Joint | generation | resistance |
| Test No. | portion (BLo) | portion (BLi) | portion (SL) | joint (DL) | strength | characteristics | reliability |
| Comparative | 1.2 | 1.2 | 2 | 0 | 105% | 105% | 0/400 |
| Example 1 | | | | | | | |
| Comparative | 1.2 | 1.2 | 0 | 2 | 130% | 95% | 0/400 |
| Example 2 | | | | | | | |
| Comparative | 1.2 | 0.8 | 2.4 | 0 | 105% | 110% | 4/400 |
| Example 3 | | | | | | | |
| Comparative | 1.2 | 0.8 | 0 | 2.4 | 130% | 90% | 4/400 |
| Example 4 | | | | | | | |
| Comparative | 1.2 | 1.2 | 2 | 0 | 100% | 100% | 0/400 |
| Example 5 | | | | | | | |
| (Cu—Sn | | | | | | | |
| bonding) | | | | | | | |
| Inventive | 1.2 | 1.6 | 1.2 | 0.4 | 115% | 115% | 0/400 |
| Example 1 | | | | | | | |
| Inventive | 1.2 | 1.6 | 1 | 0.6 | 125% | 110% | 0/400 |
| Example 2 | | | | | | | |
| Inventive | 1.2 | 1.2 | 1.6 | 0.4 | 110% | 115% | 0/400 |
| Example 3 | | | | | | | |
| Inventive | 1.2 | 1.2 | 1.4 | 0.6 | 120% | 110% | 0/400 |
| Example 4 | | | | | | | |

In the case of Inventive Examples 1 to 4 where an insulating joint and a separation portion are present between inner band portions, as suggested in the present disclosure, it can be confirmed that both the joint strength and the heat generation characteristics are superior to those of Comparative Example 5, which illustrates a conventional stack-type condenser as illustrated in FIG. 10.

In addition, in the case of Inventive Examples 1 and 2 among Inventive Examples 1 to 4 where a length (BLi) of the inner band portion is longer than a length of the outer band portion, it can be confirmed that the joint strength was superior to that of Inventive Examples 3 and 4. In particular, in the case of Inventive Examples 1 and 2 where the length of (BLi) of the inner band portion is longer, the bonding force between the external electrode and the body was superior. In addition, Inventive Examples 1 to 4 all had poor moisture resistance reliability of 0%, but it is expected that Inventive Examples 1 and 2, which had a longer inner band length (BLi), had better moisture resistance reliability.

Meanwhile, in the case of Comparative Examples 1 and 3 where there is no insulating joint between the inner band portions, the heat generation characteristics were excellent, but the joint strength was inferior to that of Inventive Examples 1 to 4.

In addition, in the case of Comparative Examples 2 and 4 where there is no separation portion between the inner band portions, it can be confirmed that the joint strength was excellent, but the heat generation characteristics were inferior to those of Comparative Example 5, a conventional example.

In addition, it can be confirmed that Comparative Examples 3 and 4 where the length (Bli) of the inner band portion is shorter than the length of the outer band portion, had inferior moisture resistance reliability.

As set forth above, one of the various effects of the present disclosure is to improve joint force between bodies by bonding adjacent bodies to an insulating joint.

One of the various effects of the present disclosure is to improve heat dissipation characteristics by disposing an insulating joint between a portion of first and second inner band portions.

One of the various effects of the present disclosure is to lower equivalent series resistance (ESR) by disposing an external electrode connecting a plurality of bodies.

However, various advantages and effects of the present disclosure are not limited to the above-described contents, and can be more easily understood in a process of explaining specific embodiments of the present disclosure.

Although the embodiments of the present disclosure have been described in detail above, the present disclosure is not limited by the above-described embodiments and the attached drawings, but is intended to be limited by the appended claims. Accordingly, various forms of substitution, modification, and change may be made by those skilled in the art within the scope that does not depart from the technical idea of the present disclosure described in the claims, and this will also fall within the scope of the present disclosure.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it can be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

While example embodiments have been illustrated and described above, it will be apparent to those skilled in the art that modifications and variations could be made without departing from the scope of the present disclosure as defined by the appended claims.

What is claimed is:

1. A composite electronic component, comprising:
an array in which two or more bodies including a dielectric layer and an internal electrode are arranged in a first direction;
a first external electrode disposed on one surface of the two or more bodies in a second direction, perpendicular to the first direction; and
a second external electrode disposed on the other surface of the two or more bodies in the second direction,
wherein the first external electrode includes a first inner band portion extending between two of the two or more bodies, which are adjacent from each other and a first outer band portion disposed on an outermost side of the body in the first direction,
the second external electrode includes a second inner band portion extending between the two of the two or more bodies, which are adjacent from each other, and a second outer band portion disposed on the outermost side in the first direction, and
an insulating joint bonding the two of the two or more bodies is disposed in a portion between the first and second inner band portions facing each other in the second direction.

2. The composite electronic component of claim 1, wherein the first inner band portion and the second inner band portion are disposed to be in contact with both of the two of the two or more bodies.

3. The composite electronic component of claim 1, wherein the first inner band portion is longer in a second direction than the first outer band portion, and
the second inner band portion is longer in the second direction than the second outer band portion.

4. The composite electronic component of claim 1, wherein the insulating joint includes a first insulating joint in contact with the first inner band portion and a second insulating joint disposed to be spaced apart from the first insulating joint in the second direction and in contact with the second inner band portion.

5. The composite electronic component of claim 1, wherein the two or more insulating joints are disposed between the first and second inner band portions facing each other in the second direction.

6. The composite electronic component of claim 1, wherein when a length of the body in the second direction is L, and
a space among spaces between the first and second inner band portions facing each other in the second direction, in which the insulating joint is not disposed, is referred to as a separation portion, and a length of the separation portion in the second direction is SL,
SL/L is 0.03 or more and 0.59 or less.

7. The composite electronic component of claim 1, wherein when the length of the body in the second direction is L, and
a length of the insulating joint in the second direction is DL,
DL/L is 0.03 or more and 0.59 or less.

8. The composite electronic component of claim 1, wherein when the length of the body in the second direction is referred to as L, and
a sum of the lengths of the first and second inner band portions in the second direction facing each other in the second direction is referred to as BLi,
BLi/L is 0.37 or more and 0.5 or less

9. The composite electronic component of claim 1, wherein when the sum of the lengths of the first and second inner band portions in the second direction facing each other in the second direction is BLi, and
a sum of the lengths of the first and second outer band portions in the second direction facing each other in the second direction is Blo,
Blo is smaller than BLi.

10. The composite electronic component of claim 1, wherein the array includes three or more bodies.

11. The composite electronic component of claim 1, wherein the first and second external electrodes include an electrode layer and a plating layer disposed on the electrode layer.

12. The composite electronic component of claim 1, wherein the first and second inner band portions have plating layers disposed only at the ends facing each other.

13. The composite electronic component of claim 1, wherein a plating layer is not formed in a central portion of the first inner band portion in the second direction and a central portion of the second inner band portion in the second direction.

14. The composite electronic component of claim 1, wherein the first and second inner band portions do not include a plating layer.

15. The composite electronic component of claim 1, wherein the insulating joint includes at least one selected from the group consisting of SiO₂, B₂O₃, BaO, CaO, Na₂O, ZnO, Al₂O₃, and PbO.
